(19) United States
(12) Patent Application Publication
(10) Pub. No.: US 2011/0119018 A1
(43) Pub. Date: May 19, 2011

(54) ESTIMATION OF AMBIENT TEMPERATURE

(75) Inventor: Filip Skarp, Lund (SE)

(73) Assignee: Sony Ericsson Mobile Communications AB, Lund (SE)

(21) Appl. No.: 12/621,820

(22) Filed: Nov. 19, 2009

(51) Int. Cl. G06F 15/00; G01K 1/00

(52) U.S. Cl. 702/130

(57) ABSTRACT

An arrangement for estimation of ambient temperature of an electronic device is disclosed. The electronic device comprises a power consuming unit, which is subject to self heating when in use. The arrangement comprises at least a first and a second temperature sensor and a processor. The sensors are adapted to produce first and second temperature measurements as functions of time respectively, and a temperature transport time to the first sensor from the power consuming unit differs from a temperature transport time to the second sensor from the power consuming unit. The processor is adapted to determine an ambient temperature estimate based at least on the first and second temperature measurements as functions of time. Corresponding method and computer program product are also disclosed.

### TECHNICAL FIELD

The present invention relates generally to the field of temperature estimation. More particularly, it relates to estimation of ambient temperature of an electronic device that comprises a power consuming unit which is subject to self heating when in use.

### BACKGROUND

In many electronic devices, for example in modern portable communication devices, the number of applications and other functionality is continuously increasing. Some of the applications and other functionality require some type of measurements to be carried out, for example measurements relating to the surrounding environment of the device. To this end, devices often comprise a number (which may be significant) of sensors. The sensors of an electronic device may, for example, include a temperature sensor, an accelerometer, a compass, a GPS receiver, a gyro.

Portable devices are often made as small as possible to make them easy to bring along. This has the implication that a temperature sensor comprised in the electronic device may be severely influenced by self heating generated by the device or by units within the device. Due to the limited size of the portable device, it may be cumbersome or even impossible to find a placement for a temperature sensor where the self heating influence is negligible. Thus, the self heating may corrupt the measurement and the reported temperature does not reflect the ambient temperature of the device but rather the device temperature.

This problem is even more severe in some devices where a temperature sensor was initially introduced in order to measure the device temperature and, for example, be able to perform temperature compensation of temperature sensitive hardware units. For such applications, a temperature sensor is typically placed close to the temperature sensitive hardware unit. However, the temperature sensitive hardware unit is often (but not always) a high power consumer and contributor to the self heating of the device. Therefore, such a placement of the temperature sensor may worsen the problem of not reflecting the ambient temperature as mentioned above. An example of a temperature sensitive hardware unit is the RF circuitry of a mobile telephone.

Thus, it may be cumbersome or even impossible to correctly measure the ambient temperature of an electronic device when the device (or units within the device) is subject to self heating.

FIG. 1 is a schematic drawing that illustrates one example scenario where the above-explained problem may be experienced. In the figure, a PCB (printed circuit board) card 100 is illustrated comprising a power consuming unit 110 (e.g. RF circuitry of a radio communication device, an image processor of a digital camera, or any high speed processor of an electronic device) and a temperature sensor 120. As long as the power consuming unit 110 is not in use (e.g. if a mobile phone is in “flight mode”, a digital camera is in “sleep mode”, etc.), the measurements made by the temperature sensor 120 will correctly reflect the ambient temperature. However, when the power consuming unit 110 is in use (e.g. during transmission/reception of a mobile phone) it will self heat and affect the surrounding temperature. Thus, since the temperature sensor 120 is located fairly close to the power consuming unit 110 it will be severely affected by this self heating and the measurements made will no longer correctly reflect the ambient temperature.

Thus, there is a need for arrangements and methods that estimate the ambient temperature of an electronic device. Self heating of the device or of units within the device should preferably not affect the correctness of the ambient temperature estimate.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It is an object of the invention to obviate at least some of the above disadvantages and to provide arrangements and methods that estimate the ambient temperature of an electronic device.

According to a first aspect of the invention, this is achieved by an arrangement for estimation of an ambient temperature of an electronic device, wherein the electronic device comprises a power consuming unit which is subject to self heating when in use. The arrangement comprises at least a first and a second temperature sensor and a processor. The first and second temperature sensors are adapted to produce first and second temperature measurements as functions of time respectively. A temperature transport time to the first sensor from the power consuming unit differs from a temperature transport time to the second sensor from the power consuming unit. The processor is adapted to determine an ambient temperature estimate based at least on the first and second temperature measurements as functions of time.

In some embodiments, the processor may be adapted to calculate a derivative over time of each of the first and second temperature measurements and determine the ambient temperature estimate based on the derivative over time of the first and second temperature measurements.

The processor may be further adapted to identify one or more derivative characteristics of the derivative over time of the first temperature measurement having corresponding simultaneous derivative characteristics of the derivative over time of the second temperature measurement, and to create an estimate of a derivative of the ambient temperature based on the identified one or more derivative characteristics. The processor may be further adapted to determine an antiderivative function (i.e. a primitive function) of the estimate of the derivative of the ambient temperature and to determine the ambient temperature estimate based on the antiderivative function of the estimate of the derivative of the ambient temperature.

In some embodiments, the processor may be further adapted to determine a derivative difference function by calculating a difference between the derivative over time of the first temperature measurement and a time shifted version of the derivative over time of the second temperature measurement, wherein the time shifted version of the derivative over time of the second temperature measurement is time shifted by a specific amount of time. The processor may be further adapted to identify one or more derivative difference function characteristics of the derivative difference function, wherein each of the derivative difference function characteristics corresponds to a counteracting derivative difference function characteristic separated from the derivative difference function characteristic by the specific amount of time, and to create the estimate of the derivative of the ambient temperature based on the identified one or more derivative difference function characteristics.

In some embodiments, the processor may be adapted to calculate a second derivative over time of each of the first and second temperature measurements and determine the ambient temperature estimate based on the second derivative over time of the first and second temperature measurements.

The processor may be further adapted to identify one or more second derivative characteristics of the second derivative over time of the first temperature measurement having corresponding simultaneous second derivative characteristics of the second derivative over time of the second temperature measurement, and to create an estimate of a second derivative of the ambient temperature based on the identified one or more second derivative characteristics. The processor may be further adapted to determine a second antiderivative function (i.e. a twice repeated antiderivative or primitive function) of the estimate of the second derivative of the ambient temperature and to determine the ambient temperature estimate based on the second antiderivative function of the estimate of the second derivative of the ambient temperature.

In some embodiments, the processor may be further adapted to determine a second derivative difference function by calculating a difference between the second derivative over time of the first temperature measurement and a time shifted version of the second derivative over time of the second temperature measurement, wherein the time shifted version of the second derivative over time of the second temperature measurement is time shifted by a specific amount of time. The processor may be further adapted to identify one or more second derivative difference function characteristics of the second derivative difference function, wherein each of the second derivative difference function characteristics corresponds to a counteracting second derivative difference function characteristic separated from the second derivative difference function characteristic by the specific amount of time, and to create the estimate of the second derivative of the ambient temperature based on the identified one or more second derivative difference function characteristics.

In some embodiments, the processor may be adapted to calculate both a derivative and a second derivative over time of each of the first and second temperature measurements and to determine the ambient temperature estimate based on the derivative over time of the first and second temperature measurements and the second derivative over time of the first and second temperature measurements.

In some embodiments, the electronic device may comprise the arrangement and the arrangement may further comprise a memory unit. In such embodiments, the processor may be further adapted to, in association with a production process of the electronic device, measure the specific amount of time and store the specific amount of time in the memory unit.

In some embodiments, a distance from the first sensor to the power consuming unit may differ from a distance from the second sensor to the power consuming unit.

A second aspect of the invention is a printed circuit board card comprising at least the power consuming unit and the arrangement of the first aspect of the invention.

A third aspect of the invention is an electronic device comprising the power consuming unit and the arrangement of the first aspect of the invention.

A fourth aspect of the invention is an electronic device comprising at least the power consuming unit, the first sensor and the processor according to the first aspect of the invention. In this aspect, the electronic device may be communicatively connectable to another electronic device comprising the second sensor according to the first aspect of the invention.

A fifth aspect of the invention is an electronic device comprising at least the second sensor and the processor according to the first aspect of the invention. In this aspect, the electronic device may be communicatively connectable to another electronic device comprising the first sensor and the power consuming unit according to the first aspect of the invention.

In some embodiments of the fourth or fifth aspect, the two electronic devices may be communicatively connectable to each other via wired communication techniques. In some embodiments of the fourth or fifth aspect, the two electronic devices may be communicatively connectable to each other via wireless communication techniques.

In some embodiments, the electronic device of the third aspect may further comprise a printed circuit board card which comprises at least the power consuming unit and the first temperature sensor. In some embodiments, the printed circuit board card does not comprise the second temperature sensor.

A fourth aspect of the invention is a method for estimation of an ambient temperature of an electronic device, wherein the electronic device comprises a power consuming unit which is subject to self heating when in use. The method comprises measuring first and second temperatures as functions of time, wherein the first temperature is measured at a location associated with a first temperature transport time from the power consuming unit, the second temperature is measured at a location associated with a second temperature transport time from the power consuming unit, and the first temperature transport time differs from the second temperature transport time. The method also comprises determining an ambient temperature estimate based at least on the first and second temperature measurements as functions of time.

In some embodiments, the measurements may be performed by temperature sensors and the determination may be performed by a processor.

In some embodiments, the step of determining an ambient temperature estimate may comprise calculating a derivative over time of each of the first and second temperature measurements, and determining the ambient temperature estimate based on the derivative over time of the first and second temperature measurements.

In some embodiments, the step of determining an ambient temperature estimate may comprise calculating a second derivative over time of each of the first and second temperature measurements, and determining the ambient temperature estimate based on the second derivative over time of the first and second temperature measurements.

In some embodiments, the step of determining an ambient temperature estimate may comprise calculating both a first and a second derivative over time of each of the first and second temperature measurements, and determining the ambient temperature estimate based on the first derivative over time of the first and second temperature measurements and on the second derivative over time of the first and second temperature measurements.

The first temperature may be measured at a first distance from the power consuming unit and the second temperature may be measured at a second distance from the power consuming unit. The first distance may differ from the second distance

A fifth aspect of the invention is a computer program product comprising a computer readable medium, having thereon a computer program comprising program instructions, the computer program being loadable into a data-processing unit and adapted to cause the data-processing unit to execute at least the step of determining an ambient temperature estimate according to the fourth aspect when the computer program is run by the data-processing unit.

In some embodiments, the fourth and fifth aspects of the invention may additionally have features identical with or corresponding to any of the various features as explained above for the first aspect of the invention.

An advantage of some embodiments of the invention is that the ambient temperature of an electronic device can be accurately estimated.

Another advantage of some embodiments of the invention is that the accuracy of the estimate is not affected by self heating of the electronic device or of units within the device.

Another advantage of some embodiments of the invention is that it is a low complexity solution.

Another advantage of some embodiments of the invention is that already existing temperature sensors, processing units and/or memory units of an electronic device may be utilized in the implementation of embodiments of the invention.

Another advantage of some embodiments of the invention is that a compact and small implementation may be provided.

### BRIEF DESCRIPTION OF THE DRAWINGS

Further objects, features and advantages of the invention will appear from the following detailed description of embodiments of the invention, with reference being made to the accompanying drawings, in which:

FIG. 1 is a block diagram illustrating an example scenario where accurate ambient temperature measurement may be cumbersome;

FIG. 2 is a block diagram illustrating an example arrangement according to some embodiments of the invention;

FIGS. 3A-D are schematic plots illustrating example results achieved when applying some embodiments of the invention;

FIGS. 4A-D are flowcharts illustrating example method steps according to some embodiments of the invention;

FIG. 5 is a flowchart illustrating example method steps according to some embodiments of the invention;

FIGS. 6A-C are block diagrams illustrating example arrangements according to some embodiments of the invention;

FIG. 7 is a schematic drawing illustrating a mobile terminal, wherein the mobile terminal may comprise an arrangement according to some embodiments of the invention; and

FIG. 8 is a schematic drawing illustrating a processing unit and a computer readable medium according to some embodiments of the invention.

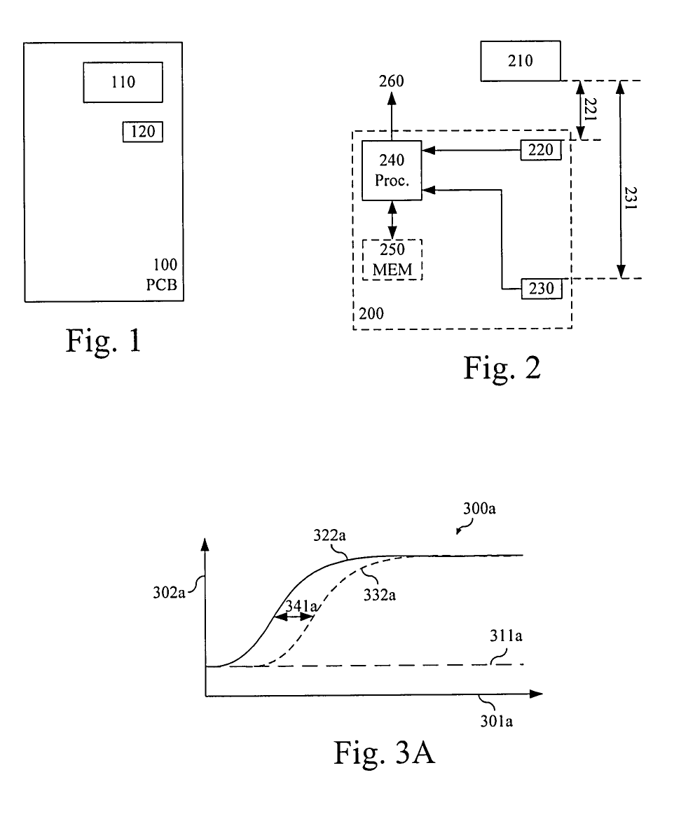

### DETAILED DESCRIPTION

In the following, embodiments of the invention will be described where the ambient temperature of an electronic device is estimated by using measurements from at least two temperature sensors. The temperature sensors are preferably located within the device so that the respective temperature transport times from a power consuming unit subject to self heating to each of the sensors are different.

In some embodiments, this is achieved by locating the sensors so that respective distances from the sensors to the power consuming unit are different.

In some embodiments the differing temperature transport times may be achieved by using shielding between the power consuming unit and at least one of the sensors. The shielding may comprise a material having particular heat conducting characteristics. If a shield is used for both of the sensors, the heat conducting characteristics of the respective materials may differ from each other.

A combination of different distances and shielding may also be considered.

Preferably, the difference in temperature transport time is as large as possible. For example, one sensor may be placed very close to the power consuming unit, and the other sensor may be placed as far away as possible from the power consuming unit but still within the electronic device. However, embodiments of the invention will be applicable also for small differences in temperature transport time.

The ambient temperature estimate may be determined based on the measurements in various ways. For example, the derivatives and/or the second derivatives (in relation to time) of the measurements may be used to identify events that are due to a change in ambient temperature and to separate such events from events that are due to the self heating of the power consuming unit.

As mentioned above there is a problem when trying to estimate the ambient temperature of an electronic device in that it is necessary to differentiate between temperature changes due to self heating ΔT_{self} and temperature changes due to ambient change ΔT_{amb}.

FIG. 2 illustrates an example arrangement 200 that solves this problem according to some embodiments of the invention. The example arrangement 200 comprises a first sensor 220 and a second sensor 230. The first sensor 220 is located at a first distance 221 from a power consuming unit 210 that is subject to self heating when in use. The second sensor 230 is located at a second distance 231 from the power consuming unit 210. The first distance 221 is different from the second distance 231.

The example arrangement also comprises a processing unit 240, adapted to use the measurements reported from the sensors 220, 230 to estimate an ambient temperature. Different example methods for performing such estimation will be elaborated on in the following. The ambient temperature estimate may then be used for further purposes in e.g. services or applications as illustrated by the arrow 260. The further purposes may be any purpose at all where an accurate estimate of the ambient temperature is needed or desired. In one example application, a photograph is tagged with the estimated ambient temperature at the time the photograph was taken.

The arrangement may also comprise a memory unit 250. For example, the memory unit 250 may be used to store at least some of a measurement history for the sensors 220, 230. The memory unit 250 may also or alternatively be used to store intermediate results for calculations carried out by the processing unit 240.

If a device comprising an arrangement according to some embodiments of the invention (e.g. the arrangement 200 of FIG. 2) is left under the same conditions for a long enough time, the two temperature sensors will show the same measured temperature. However, if the power consuming unit is in use, the measured temperature will not reflect the ambient temperature, but rather the ambient temperature together with temperature due to self heating as explained above.

Due to the different temperature transport time (which may, for example, be due to the temperature response time of the PCB and differing distances between a power consuming unit and sensors on the PCB), the sensors will show different measured temperatures during the self heating process of the device. This difference may be used to compensate for the self heating and thereby be able to estimate the ambient temperature correctly (or at least close to correctly).

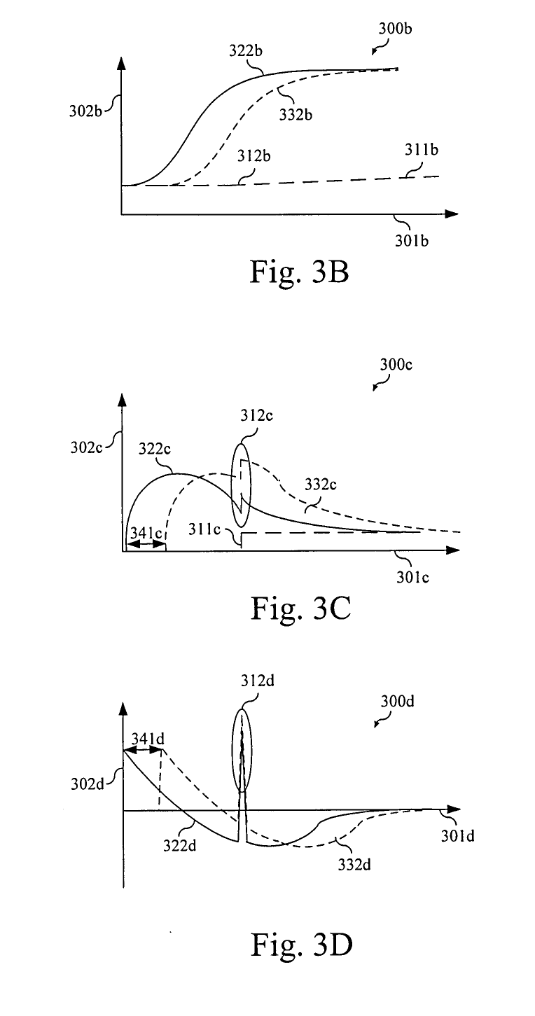

An example typical temperature response from two sensors arranged according to embodiments of the invention is illustrated in the plot 300a of FIG. 3A. The x-axis 301a of the plot represents a time flow, and the y-axis 302a represents measured temperature by the sensors.

The dashed line 311a represents the true ambient temperature (which cannot always be measured as explained above). In this example plot, it is assumed that the ambient temperature is constant. The solid line 322a represent measurements of one of the sensors (e.g. the sensor closest to the power consuming unit) and the dashed line 332a represent measurements of the other one of the sensors (e.g. the sensor furthest away from the power consuming unit).

At the start of the measurement (e.g. at startup of the device), both sensors show the same temperature (the ambient temperature). Once the power consuming unit is used, the self heating will start. Then, the sensor closest to the power consuming unit will start recording an increase in temperature.

The self heating is propagates through the device (e.g. via PCB and mechanics of the device) and eventually reaches also the other sensor. Thus, the other sensor will register the same temperature increase, but there will be a time shift between the measured temperature increases as illustrated at 341a. This time shift may also be denoted temperature transfer latency.

The presence of the time shift 341a may be taken as an indication that the temperature increase is not an ambient temperature increase but is due to self heating of the device. Put differently, it may be concluded that as long as there is not any change in measured temperature that is registered by both sensors simultaneously, any changes in measured temperature are due to self heating.

Eventually, the two sensors will again show the same measured temperature, as indicated in FIG. 3A. These measured temperatures represent the ambient temperature overlaid with the self heating temperature.

The value of the time shift may typically be specific for the used arrangement (and thus specific for the device). It can be determined (e.g. measured) during or after manufacturing of the device and stored in the device (e.g. in a memory unit of the device).

For example, for a mobile phone the first sensor may be mounted close to the RF (radio frequency) parts of the phone and the second sensor may be mounted as far away as possible from the RF parts. During the RF calibration, the RF transmitter will be running at maximum power causing self heating. The value of the time shift may be determined in this process by simply registering the time difference between the temperature increases in the sensors.

In some embodiments, several time shift values are determined and stored. For example, the value of the time shift may differ for different types and/or magnitudes of (ambient and/or self heating) temperature changes.

Alternatively, a predetermined and specified value of the time shift may be assumed.

Yet alternatively or additionally, the value of the time shift may be determined adaptively. For example, the value may be determined by logging the time differences between changes in the two sensors for each or some of the changes that occur during use and change the value of the stored time shift accordingly.

FIG. 3B illustrates a plot 300b of an example typical temperature response similar to that of FIG. 3A. As before, the x-axis 301b of the plot represents a time flow, the y-axis 302b represents measured temperature by the sensors, and the dashed line 311b represents the true ambient temperature T_{amb}(t). In this scenario, however, it is assumed that there is a slight, linear temperature increase of the ambient temperature starting at t₀ 312b.

As before, the solid line 322b represents measurements T₁(t) of one of the sensors and the dashed line 332b represents measurements T₂(t) of the other one of the sensors.

As can be seen from FIG. 3B, it is quite uncertain whether it will be possible to detect the slight temperature increase of the ambient temperature when, simultaneously, there is a temperature increase due to self heating of the device.

However, if the time shift Δt (341a of FIG. 3A) is known, a calculation of T_{diff}(t)=T₁(t)−T₂(t−Δt) may be used to determine an estimation of the true ambient temperature as T_{amb,est}(t)=Σ_{k=0 . . . infinity} T_{diff}(t₀+kΔt) according to some embodiments of the invention.

In some embodiments of the invention, the derivatives and/or the second derivatives of the measurements T₁(t) and T₂(t) of the sensors may be used to determine an estimation of the true ambient temperature as will be illustrated in the following. Any of these approaches may be used alone or in combination with each other or with the approach explained above in connection to FIG. 3B. If a combination of algorithms is considered, one possible approach of determining an ambient temperature estimate is to determine an estimate for each of the algorithms and then use an average, median or other function of the estimates as a final estimate.

FIG. 3C illustrates a derivative plot 300c corresponding to the scenario of FIG. 3B. As before, the x-axis 301c of the plot represents a time flow. The y-axis 302c represents the derivative over time of the measured temperatures. The dashed line 311c represents the derivative of the true ambient temperature dT_{amb}(t)/dt. The slight, linear temperature increase of the ambient temperature starting at tₒ manifests itself as a step in the derivative.

The solid line 322c represents the derivative dT₁(t)/dt of the measurements of one of the sensors and the dashed line 332c represents the derivative dT₂(t)/dt of the measurements of the other one of the sensors.

The time shift is clearly visible, 341c, and the slight, linear temperature increase of the ambient temperature, which was hardly distinguishable in FIG. 3B, manifests itself clearly as a step 312c in the derivative.

A calculation of dT_{diff}(t)/dt=dT₁(t)/dt−dT₂(t−Δt)/dt may be used to determine an estimation of the derivative of the true ambient temperature as dT_{amb,est}(t)/dt=Σ_{k=0 . . . infinity}dT_{diff}(t₀+kΔt)/dt according to some embodiments of the invention. Then, an estimation of the true ambient temperature may be taken as the primitive function (antiderivative) of dT_{amb,est}(t)/dt. The constant term of the primitive function may be determined based on the initial temperature measurements when the device was started up, since these measurements represent the true ambient temperature at that time.

In some embodiments, rather than using the exact calculations above, an identification algorithm may be deployed that identifies characteristics of the derivative dT₁(t)/dt having corresponding simultaneous characteristics of the derivative dT₂(t)/dt and creates an estimate dT_{amb,est}(t)/dt based on the identified characteristics. For example, identifying simultaneous steps (compare with 312c) in otherwise smooth derivative functions may lead to a conclusion that dT_{amb,est}(t)/dt should have a step of that magnitude at that time.

In some embodiments, also rather than using the exact calculations above, an identification algorithm may be deployed that identifies characteristics in dT_{diff}(t)/dt that has a corresponding, but counteracting, characteristic separated from the first characteristic by a time corresponding to the time shift. Then, an estimate dT_{amb,est}(t)/dt may be created based on the identified characteristics. For example, identifying a positive step in dT_{diff}(t)/dt followed (after the time shift) by a negative step of the same or similar magnitude may lead to a conclusion that dT_{amb,est}(t)/dt should have a positive step of that magnitude.

FIG. 3D illustrates a plot 300d of second derivatives corresponding to the scenario of FIG. 3B. As before, the x-axis 301d of the plot represents a time flow. The y-axis 302d represents the second derivative over time of the measured temperatures. The true ambient temperature is not included in this plot.

The solid line 322d represents the second derivative d² T₁(t)/dt² of the measurements of one of the sensors and the dashed line 332d represents the second derivative d² T₂(t)/dt² of the measurements of the other one of the sensors.

The time shift is clearly visible, 341d, and the slight, linear temperature increase of the ambient temperature, which was hardly distinguishable in FIG. 3B, manifests itself clearly as a peak 312d in the second derivative.

A calculation of d² T_{diff}(t)/dt²=d² T₁(t)/dt²−d² T₂(t−Δt)/dt² may be used to determine an estimation of the second derivative of the true ambient temperature as d² T_{amb,est}(t)/dt²=Σ_{k=0 . . . infinity}d² T_{diff}(t₀+kΔt)/dt² according to some embodiments of the invention. Then, an estimation of the true ambient temperature may be taken as the second primitive function of d² T_{amb,est}(t)/dt². The constant terms of the primitive function may be determined based on the initial temperature measurements (and its derivative) when the device was started up, since these measurements represent the true ambient temperature at that time.

In some embodiments, rather than using the exact calculations above, an identification algorithm may be deployed that identifies characteristics of the second derivative d² T₁(t)/dt² having corresponding simultaneous characteristics of the derivative d² T₂(t)/dt² and creates an estimate d² T_{amb,est}(t)/dt² based on the identified characteristics. For example, identifying simultaneous peaks (compare with 312d) in otherwise smooth second derivative functions may lead to a conclusion that d² T_{amb,est}(t)/dt² should have a peak of that magnitude at that time.

In some embodiments, also rather than using the exact calculations above, an identification algorithm may be deployed that identifies characteristics in d² T_{diff}(t)/dt² that has a corresponding, but counteracting, characteristic separated from the first characteristic by a time corresponding to the time shift. Then, an estimate d² T_{amb,est}(t)/dt² may be created based on the identified characteristics. For example, identifying a positive peak in d² T_{diff}(t)/dt² followed (after the time shift) by a negative peak of the same or similar magnitude may lead to a conclusion that d² T_{amb,est}(t)/dt² should have a positive peak of that magnitude.

It is emphasized that the plots illustrated in FIGS. 3A-D are merely schematic plots meant to illustrate approaches according to embodiments of the invention. For example, there has been no ambition to illustrate the exact derivatives in FIG. 3C or the exact second derivatives in FIG. 3D.

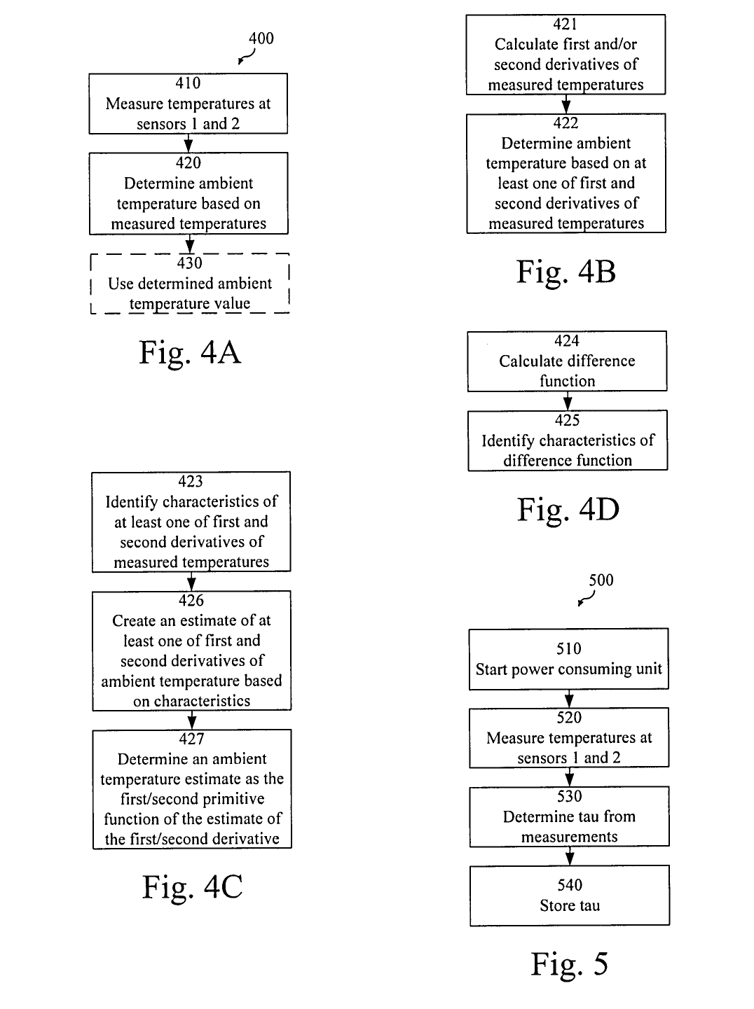

FIG. 4A illustrates an example method 400 according to embodiments of the invention. The method 400 may, for example, be carried out by the example arrangement 200 of FIG. 2.

In step 410, two sensors (sensor 1 and 2) measure respective temperatures. The measurements may be forwarded to a processing unit and/or they may be temporarily stored at a memory unit.

In step 420, the ambient temperature is determined based on the temperature measurements of step 410. For example, step 420 may employ any of the estimation methods that have been explained in connection to FIGS. 3A-D.

In optional step 430, the determined ambient temperature value is used in, e.g., a service or an application.

FIG. 4B illustrates method sub-steps that may be employed in step 420 of FIG. 4A. In sub-step 421, first and/or second derivatives over time are calculated for the temperature measurements of step 410. In sub-step 422, the ambient temperature is determined based on either or both of the first and second derivatives of sub-step 421.

FIG. 4C illustrates method sub-steps that may be employed in sub-step 422 of FIG. 4B. In sub-step 423, characteristics of the first and/or second derivatives of sub-step 421 are identified. For example, characteristics may be identified as explained above in relation to FIGS. 3C-D. In sub-step 426, an estimate of the first and/or second derivative of the ambient temperature is created based on the characteristics identified in sub-step 423. Then, in sub-step 427, the ambient temperature is determined based on the estimate of the first and/or second derivative of the ambient temperature of sub-step 427 via calculation of first and/or second primitive functions.

FIG. 4D illustrates method sub-steps that may be employed in sub-step 423 of FIG. 4C. In sub-step 424, a difference function is calculated between the two first derivatives and/or the two second derivatives. In sub-step 425, characteristics of the difference function are identified (e.g. as explained above in relation to FIGS. 3C-D).

FIG. 5 illustrates an example method 500 for determining and saving the time shift value according to some embodiments of the invention. In step 510, a power consuming unit is started up (thus, initiating the self heating process).

In step 520, two sensors (sensor 1 and 2) measure respective temperatures. It is noteworthy that it may be beneficial, for achieving as accurate estimation as possible of the time shift value, to keep the ambient temperature as constant as possible during the measurement phase.

The time shift value (tau) is determined in step 530 based on the measurements of step 520, and stored in step 540 (e.g. in a memory unit of the electronic device).

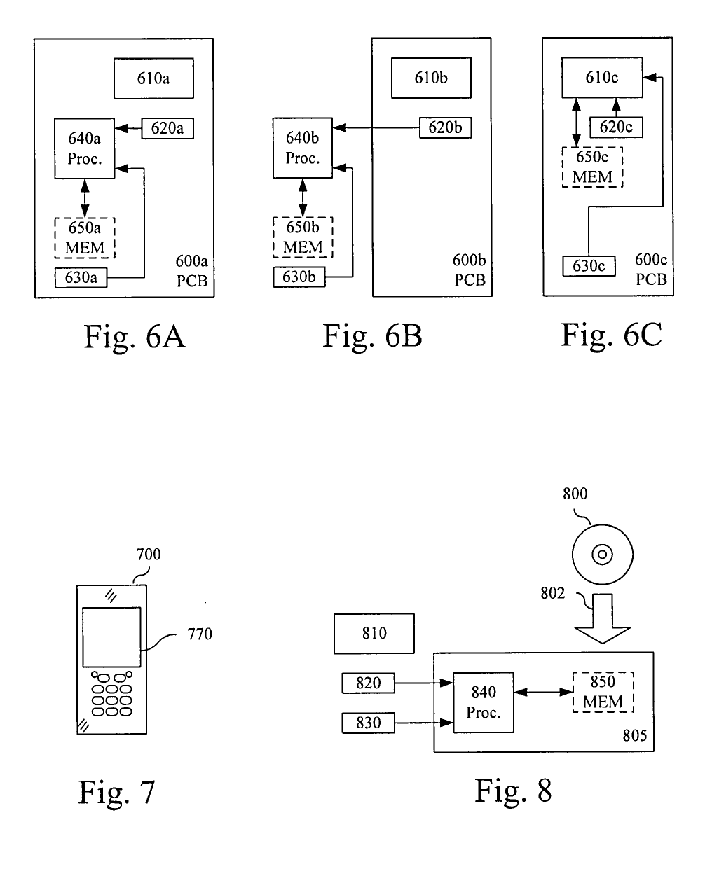

FIG. 6A-C illustrate example locations of an arrangement according to embodiments of the invention in relation to a power consuming unit (610a, 610, b, 610c) located on a PCB (600a, 600, b, 600c).

In FIG. 6A, the entire arrangement comprising first and second sensors 620a, 630a, a processing unit 640a and an optional memory unit 650a is located on the PCB 600a.

In FIG. 6B, only the first sensor 620b is located on the PCB 600b. The rest of the arrangement comprising the second sensor 630b, a processing unit 640b and an optional memory unit 650b is located elsewhere.

In FIG. 6C, the entire arrangement comprising first and second sensors 620c, 630c and an optional memory unit 650c is located on the PCB 600c. In this embodiment, the processing unit is integral with the power consuming unit 610c.

FIG. 7 illustrates an example mobile terminal 700 which may comprise arrangements or perform methods according to embodiments of the invention. The mobile terminal 700 may, for example, comprise an arrangement as described in connection to any of the FIGS. 2 and 6A-C. Alternatively or additionally, the mobile terminal 700 may, for example, perform method steps as described in connection to any of the FIGS. 4A-D and 5.

The mobile terminal may further comprise a display 770 and/or other man-machine interfaces for presenting the ambient temperature measurement to a user of the mobile terminal.

In some embodiments of the invention, the example mobile terminal 700 may comprise only part of an arrangement as described in connection to any of the FIGS. 2 and 6A-C. For example, the mobile terminal 700 may comprise a power consuming unit (e.g. a processing unit) subject to self heating and a first sensor. In such embodiments, a second sensor may be located in another, e.g. auxiliary, electronic device such as a headset connectable to the mobile terminal 700. This auxiliary electronic device may communicate with the mobile terminal 700 in any suitable way, e.g. via Bluetooth or other wireless communication techniques, or via wired communication. In embodiments where the two sensors are located in different electronic devices, each of the processor and the optional memory may be located in either of the electronic devices.

The described embodiments of the invention and their equivalents may be realised in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of the invention.

The invention may be embodied within an electronic apparatus comprising circuitry/logic or performing methods according to any of the embodiments of the invention. The electronic apparatus may, for example, be a portable or handheld mobile radio communication equipment, a mobile radio terminal, a mobile telephone, a communicator, an electronic organizer, a smartphone, a computer, a notebook, a mobile gaming device, a digital camera, or a (wrist) watch.

According to some embodiments of the invention, a computer program product comprises a computer readable medium such as, for example, a diskette or a CD-ROM. The computer readable medium may have stored thereon a computer program comprising program instructions. The computer program may be loadable into a data-processing unit, which may, for example, be comprised in a mobile terminal. When loaded into the data-processing unit, the computer program may be stored in a memory associated with or integral to the data-processing unit. According to some embodiments, the computer program may, when loaded into and run by the data-processing unit, cause the data-processing unit to execute method steps according to, for example, the methods shown in any of the FIGS. 4A-D and 5.

FIG. 8 is a schematic drawing illustrating a computer readable medium in the form of a CD-ROM 800 according to some embodiments of the invention. The CD-ROM 800 may have stored thereon a computer program comprising program instructions. The computer program may be loadable (as shown by arrow 802) into an electronic device 805 comprising a processing unit 840 and possibly a separate memory unit 850. When loaded into the electronic device 805, the computer program may be stored in the memory unit 850. According to some embodiments, the computer program may, when loaded into the electronic device 805 and run by the processing unit 840, cause the electronic device 805 and sensors 820 and 830 (associated or integral with the electronic device 805) to execute method steps according to, for example, any of the methods shown in any of the FIGS. 4A-D and 5.

The invention has been described herein with reference to various embodiments. However, a person skilled in the art would recognize numerous variations to the described embodiments that would still fall within the scope of the invention. For example, the method embodiments described herein describes example methods through method steps being performed in a certain order. However, it is recognized that these sequences of events may take place in another order without departing from the scope of the invention. Furthermore, some method steps may be performed in parallel even though they have been described as being performed in sequence.

In the same manner, it should be noted that in the description of embodiments of the invention, the partition of functional blocks into particular units is by no means limiting to the invention. Contrarily, these partitions are merely examples. Functional blocks described herein as one unit may be split into two or more units. In the same manner, functional blocks that are described herein as being implemented as two or more units may be implemented as a single unit without departing from the scope of the invention.

Hence, it should be understood that the limitations of the described embodiments are merely for illustrative purpose and by no means limiting. Instead, the scope of the invention is defined by the appended claims rather than by the description, and all variations that fall within the range of the claims are intended to be embraced therein.

1. An arrangement for estimation of an ambient temperature of an electronic device, wherein the electronic device comprises the a power consuming unit which is subject to self heating when in use, comprising:
at least a first and a second temperature sensor, adapted to produce first and second temperature measurements as functions of time respectively, wherein a temperature transport time to the first sensor from the power consuming unit differs from a temperature transport time to the second sensor from the power consuming unit; and
a processor adapted to determine an ambient temperature estimate based at least on the first and second temperature measurements as functions of time.

2. The arrangement of claim 1, wherein the processor is adapted to:
calculate a derivative over time of each of the first and second temperature measurements; and
determine the ambient temperature estimate based on the derivative over time of the first and second temperature measurements.

3. The arrangement of claim 2, wherein the processor is further adapted to:
identify one or more derivative characteristics of the derivative over time of the first temperature measurement having corresponding simultaneous derivative characteristics of the derivative over time of the second temperature measurement;
create an estimate of a derivative of the ambient temperature based on the identified one or more derivative characteristics;
determine an antiderivative function of the estimate of the derivative of the ambient temperature; and
determine the ambient temperature estimate based on the antiderivative function of the estimate of the derivative of the ambient temperature.

4. The arrangement of claim 3, wherein the processor is further adapted to:
determine a derivative difference function by calculating a difference between the derivative over time of the first temperature measurement and a time shifted version of the derivative over time of the second temperature measurement, wherein the time shifted version of the derivative over time of the second temperature measurement is time shifted by a specific amount of time;
identify one or more derivative difference function characteristics of the derivative difference function, wherein each of the derivative difference function characteristics corresponds to a counteracting derivative difference function characteristic separated from the derivative difference function characteristic by the specific amount of time; and
create the estimate of the derivative of the ambient temperature based on the identified one or more derivative difference function characteristics.

5. The arrangement of claim 1, wherein the processor is adapted to:
calculate a second derivative over time of each of the first and second temperature measurements; and
determine the ambient temperature estimate based on the second derivative over time of the first and second temperature measurements.

6. The arrangement of claim 5, wherein the processor is further adapted to:
identify one or more second derivative characteristics of the second derivative over time of the first temperature measurement having corresponding simultaneous second derivative characteristics of the second derivative over time of the second temperature measurement;
create an estimate of a second derivative of the ambient temperature based on the identified one or more second derivative characteristics;
determine a second antiderivative function of the estimate of the second derivative of the ambient temperature; and
determine the ambient temperature estimate based on the second antiderivative function of the estimate of the second derivative of the ambient temperature.

7. The arrangement of claim 6, wherein the processor is further adapted to:
determine a second derivative difference function by calculating a difference between the second derivative over time of the first temperature measurement and a time shifted version of the second derivative over time of the second temperature measurement, wherein the time shifted version of the second derivative over time of the second temperature measurement is time shifted by a specific amount of time;
identify one or more second derivative difference function characteristics of the second derivative difference function, wherein each of the second derivative difference function characteristics corresponds to a counteracting second derivative difference function characteristic separated from the second derivative difference function characteristic by the specific amount of time; and
create the estimate of the second derivative of the ambient temperature based on the identified one or more second derivative difference function characteristics.

8. The arrangement of claim 4, wherein the electronic device comprises the arrangement and the arrangement further comprises a memory unit, and wherein the processor is further adapted to, in association with a production process of the electronic device, measure the specific amount of time and store the specific amount of time in the memory unit.

9. The arrangement of claim 1, wherein a distance from the first sensor to the power consuming unit differs from a distance from the second sensor to the power consuming unit

10. A printed circuit board card comprising at least the power consuming unit and the arrangement of claim 1.

11. An electronic device comprising the power consuming unit and the arrangement of claim 1.

12. (canceled)

13. (canceled)

14. The electronic device of claim 11, further comprising a printed circuit board card comprising at least the power consuming unit and the first temperature sensor, wherein the printed circuit board card does not comprise the second temperature sensor.

15. A method for estimation of an ambient temperature of an electronic device, wherein the electronic device comprises a power consuming unit which is subject to self heating when in use, comprising:
measuring first and second temperatures as functions of time, wherein the first temperature is measured at a location associated with a first temperature transport time from the power consuming unit, the second temperature is measured at a location associated with a second temperature transport time from the power consuming unit, and the first temperature transport time differs from the second temperature transport time; and
determining an ambient temperature estimate based at least on the first and second temperature measurements as functions of time.

16. The method of claim 15, wherein the step of determining an ambient temperature estimate comprises:
calculating a derivative over time of each of the first and second temperature measurements; and
determining the ambient temperature estimate based on the derivative over time of the first and second temperature measurements.

17. The method of claim 15, wherein the step of determining an ambient temperature estimate comprises:
calculating a second derivative over time of each of the first and second temperature measurements; and
determining the ambient temperature estimate based on the second derivative over time of the first and second temperature measurements.

18. The method of claim 15, wherein the first temperature is measured at a first distance from the power consuming unit, the second temperature is measured at a second distance from the power consuming unit, and the first distance differs from the second distance.

19. A computer program product comprising a computer readable medium, having thereon a computer program comprising program instructions, the computer program being loadable into a data-processing unit and adapted to cause the data-processing unit to execute at least the step of determining an ambient temperature estimate according to claim 15 when the computer program is run by the data-processing unit.

20. A first electronic device, being communicatively connectable to a second electronic device comprising a second temperature sensor adapted to produce second temperature measurements as a function of time, the first electronic device comprising:
a power consuming unit which is subject to self heating when in use;
a first temperature sensor adapted to produce first temperature measurements as a function of time; and
a processor adapted to determine an ambient temperature estimate of the first electronic device based at least on the first and second temperature measurements as functions of time;
wherein a temperature transport time to the first sensor from the power consuming unit differs from a temperature transport time to the second sensor from the power consuming unit.

21. A second electronic device, being communicatively connectable to a first electronic device comprising a power consuming unit which is subject to self heating when in use and a first temperature sensor adapted to produce first temperature measurements as a function of time, the second electronic device comprising:
a second temperature sensor adapted to produce second temperature measurements as a function of time; and
a processor adapted to determine an ambient temperature estimate of the first electronic device based at least on the first and second temperature measurements as functions of time;
wherein a temperature transport time to the first sensor from the power consuming unit differs from a temperature transport time to the second sensor from the power consuming unit.
